(19) United States
(12) Patent Application Publication
(10) Pub. No.: US 2024/0248892 A1
(43) Pub. Date: Jul. 25, 2024

(54) SYSTEM AND METHOD FOR MANAGING INFORMATION RELATED TO DIGITAL ASSETS

(71) Applicant: Perpetual Block AG, Zug (CH)

(72) Inventors: Nitish Jain, Jaipur (IN); Rahul Malu, Kota (IN); Rohit Anurag, Bokaro (IN); Ashlesha Arjun Patil, Kolhapur (IN); Gazzela Vivakar, Gajapati (IN)

(73) Assignee: Perpetual Block AG, Zug (CH)

(21) Appl. No.: 18/101,547

(22) Filed: Jan. 25, 2023

(51) Int. Cl. G06F 16/23

(52) U.S. Cl. CPC G06F 16/2379

(57) ABSTRACT

Disclosed herein is a system and a computer implemented method for deduplication of information pertaining to an asset listed in one or more auction houses or auction aggregator platform. The method disclosed herein relates to identifying data records that relate to a single asset and therefore should be stored as a single entry rather than multiple entries pertaining to same asset. The method compares data records for bibliographic similarity, price similarity and image similarity to identify mergeable data records. Based on the comparison, mergeable data records are merged into a single config file pertaining to an asset. Furthermore, the config file is updated based on receipt of new information or information available from a higher trusted source.

### TECHNICAL FIELD

This disclosure relates to generally to computer systems and processes for information storages, and, more particularly, to managing and storing non duplicate information pertaining to one or more digital assets.

### BACKGROUND

NFTs, paintings, artworks etc. have been quite popular amongst urban crowd. People tend to stock these collections with them for the purpose of enjoyment, reputation and as a collection masterpiece. These assets are auctioned throughout the world in various auction houses. The auction houses maintain the information pertaining to these assets. Given the internet age, said information is also maintained in digital files for easy accessibility by the public. Further, there are several auction house aggregators that collate information from the auction houses on each item and display on their portals. However, in several cases, information pertaining to same asset ends up in catalogues as distinct entries leading to duplication. This generally occurs to disparity in standards of recording information across auction houses and aggregator platforms.

Conventionally, auction records and corresponding information have been manually collated by professionals who ensure that duplicate entries are weeded off. Manual intervention results in identifying similar records and thereby merging them into a single record for the purpose of storage. Further, there are automated systems that compare the two records and detect any similarity between the two set of information, pursuant to which records are collated into a single record.

Manual intervention-based deduplication requires extensive amount of time, labor and cost. Moreover, said manual exercises are always prone to human error of judgment as well as passthrough errors. Furthermore, the automated systems based on similarity mapping are not accurate owing to mismatch in data recording, incomplete information across auction house's websites and varying standards of information recordal.

In light of above mentioned problems, there does not exist a solution that provides a automated and accurate method for storing deduplicated information pertaining to one or more assets and it is desirable to have a system and process that allows deduplication of records pertaining to same asset and collating all information related a single asset into a single record.

### SUMMARY

The present disclosure seeks to provide a system and a computer implemented method for deduplication of information pertaining to an asset listed in one or more auction houses or auction aggregator platform. The method disclosed herein relates to identifying data records that relate to a single asset and therefore should be stored as a single entry rather than multiple entries pertaining to same asset. The method compares data records for bibliographic similarity, price similarity and image similarity to identify mergeable data records. Based on the comparison, mergeable data records are merged into a single config file pertaining to an asset. Furthermore, the config file is updated based on receipt of new information or information available from a higher trusted source.

Embodiments of the present disclosure substantially eliminate or at least partially address the aforementioned problems.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts the block diagram of the exemplary system as per the present disclosure.

FIG. 2 is a flow chart depicting the method steps of the present invention.

It will be appreciated that the drawings illustrated herein are for representation purposes only and do not intend to limit the scope of the present disclosure, and actual implementation of the present disclosure may be viewed substantially differently.

### DETAILED DESCRIPTION

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

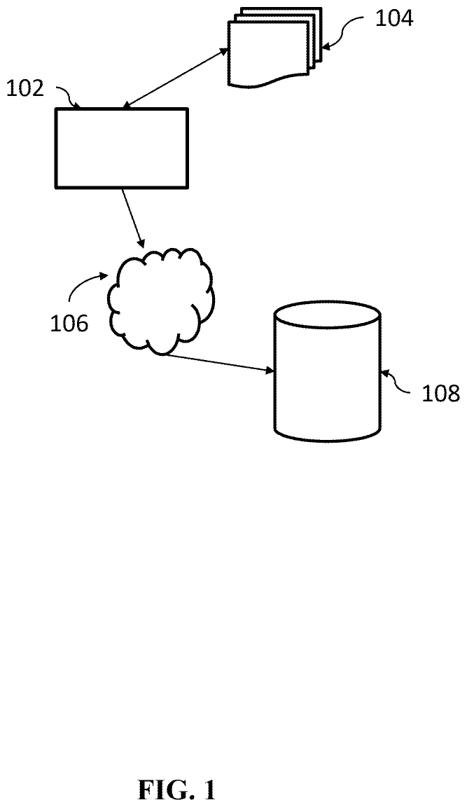

Referring to FIG. 1, the system comprises a processor 102 with a memory 104 comprising executable non-transitory machine-readable instructions wherein the processor 102 is configured to execute the said machine-readable instructions, and wherein the processor 102 is communicably coupled to a database arrangement 106 via a data communication network 108. The processor 102 is configured to retrieve one or more data sets pertaining to assets from a plurality of data sources and identify one or more mergeable data records from the retrieved one or more data sets. The mergeable data records are merged into a single config file corresponding to an asset.

Throughout this disclosure, the term “data sources” means websites of auction houses and aggregator platforms that hosts auction houses data. These data sources contain information of all auctions that have taken place related to one or more assets within their rules and procedures. The term “data sets” means information pertaining to auction details of an asset such as lot number, sale price, event date, creation date, location etc. Further, the term “asset” refers to an item which is subject to auction in auction houses. Said items can be vintage cars, paintings, NFTs or sculpture works.

The database arrangement 106 comprises information pertaining to a plurality of assets. Information pertaining to each asset is stored in form a configuration file which is distinct for each asset. Each configuration file is assigned a unique identifier that corresponds to a distinct asset. Further, the configuration file has several fields depicting information related to the asset such as suction house, location, sale date, price, images etc. Each of the fields of the configuration file for an asset is tagged with a source id that describes the data source from where the relevant information for the field was sourced.

In an aspect of the present invention, the processor 102 is operable to retrieve one or more data sets from a plurality of data sources. The retrieval of data sets occurs in an automated manner by crawling each of the data sources to extract information from the respective data sources and aggregate them into data sets pertaining to an asset. Each data set is assigned an identifier based on the data source they have been extracted from by the processor 102. Alternatively, said data sets can be manually fed to the processor for further operations.

In an embodiment, the plurality of data sources are ranked based on their credibility, number of auctions, average price of auctions, reputation, data coverage and granularity of data and frequency of data updates. If the auction house is a very reputed one, such auction house's website is ranked higher as compared to a newly listed auction house. As such, information from a higher ranked data source shall be accorded greater importance by the processor and shall be used to update information from a lower ranked source. Similarly, a data source with extensive data coverage shall be accorded a higher rank as compared to a data source with sparse information related to auction of an asset.

The information within the retrieved data sets is one of a bibliographic data, price data and image pertaining the asset. Non limiting examples of information within the said data sets are images, creation year, auction house name, location, lot number, provenance, name of creator, hammer price of asset in last auction, literature references and past auction details.

Generally, traditional existing solutions store the data sets retrieved from each data source as a separate entry without ascertaining if the data sets from different data sources relate to the same asset. This leads to duplication of records pertaining to same asset. The present solution overcomes this problem by merging data sets that relate to a single distinct asset.

The processor 102 is operable to identify mergeable data records from the retrieved data sets. Throughout this disclosure the term “mergeable data records” refer to those data sets that contain information pertaining to the same asset. As an example, if data set 1 contains data record pursuant to lot number, sale price and sale date and data set 2 contains data records such as lot number, sale price and creation date wherein both the data record relate to a single asset. In such case, data set 1 and data set 2 are mergeable data records.

In an aspect of the present invention, the processor 102 identifies mergeable data records from the retrieved data sets by comparing the data records across the data sets. As an example, data records within data set 1 is compared with data records within data set 2. In a preferred embodiment of the present invention, the processor is operable to compare the data sets in a sequential manner wherein the bibliographic data records are first compared to identify mergeable data records. If the mergeable data records are identified on account of similar information such as same lot number, same event date, same creation date etc., then the data records of both the data sets are merged into a single configuration file pertaining to the asset stored in the digital repository. If the data records are not found to be similar, the processor 102 then compares price data records of the data sets to identify similar price data. If price data is found to be similar or within a predefined custom price ratio, the processor 102 merges both the data sets into a single configuration file pertaining to the asset stored in the digital repository. If the data records are still not found mergeable, the processor 102 then compares the images within the data sets to identify if the data sets relate to the same asset.

In an embodiment of the present invention, the data records within the retrieved data sets are pre-processed to a standard format prior to comparison.

Once the processor 102 identifies mergeable data records, the processor 102 merges the mergeable data records into a single configuration file pertaining to the asset. Alternatively, the processor 102 is further configured to update one or more data records within the configuration file pertaining to the asset from the mergeable data records. This results in enrichment of the configuration file wherein the missing details are updated by identifying similar data records with extensive coverage.

The processor 102 is further configured to update the configuration file with merged data records within the database arrangement. Optionally, in case no mergeable data records are found, the processor creates a new configuration file pertaining to a new asset and stores it within the database arrangement 108.

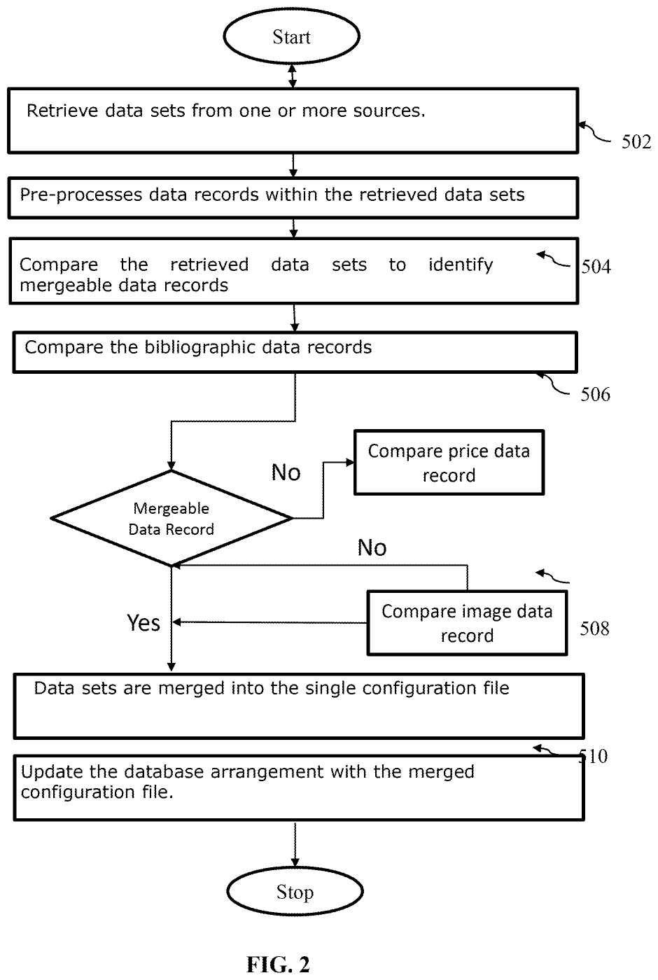

FIG. 2 is a flow chart 200 depicting the methods steps of the present disclosure. At step 202, the processor 102 retrieves data sets from one or more sources. At step 204, the processor 102 pre-processes data records within the retrieved data sets. Further, at step 206, the processor 102 compares the retrieved data sets to identify mergeable data records. At step 208, the processor 102 compares the bibliographic data records. If similar data records are found, the data sets are merged into a single configuration file. Else, at step 210, the processor 102 compares the price data of the retrieved data sets to identify data sets pertaining to same asset. If the mergeable data records are identified, the data sets are merged into the single configuration file. Else, at step 212, the processor 102 compares the image data from the data records. If the image data results in identification of mergeable data records, the data sets are merged into the single configuration file. Finally, at step 214, the processor 102 updates the database arrangement 108 with the merged configuration file.

Optionally, the processor 102 is further configured to identify the data records and a rank associated with their data source. The processor 102 then compares the data records within the configuration file corresponding to the asset with the data records within the retrieved data sets. The data records in the configuration file corresponding to the asset is replaced with the data records with higher ranked public source from the retrieved data sets.

In yet another aspect of the present invention, the processor 102 is further operable to generate a time series data of all the auctions corresponding to the asset.

The data communication network may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of the foregoing.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface.

In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor 102 in a modular or integrated manner. As used herein a processor 102 includes a single-core processor, multi-core processor 102 on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Moreover, it will be appreciated that the server arrangement can be implemented by way of a single hardware server. The server arrangement can alternatively be implemented by way of a plurality of hardware servers operating in a parallel or distributed architecture. As an example, the server arrangement may include components such as a memory unit, a processor, a network adapter, and the like, to store and process information pertaining to the document and to communicate the processed information to other computing components, for example, such as a client device. Furthermore, the server arrangement comprises a database arrangement for storing data therein.

Any of the software components or functions described in this application may be implemented as software code to be executed by a processor 102 using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

1-20. (canceled)

21. A system for managing information, the system comprising a processor configured to execute non-transitory machine-readable instructions that when executed configures the processor to:
retrieve one or more data sets pertaining to an asset from a plurality of data sources;
identify one or more mergeable data records from the one or more data sets wherein identifying the mergeable data records comprises:
comparing a bibliographic set of data records;
comparing a price data record; and
comparing images from each of the one or more data sets;
combine the mergeable data records into a config file pertaining to the asset; and
update a database arrangement with the config file wherein the database arrangement comprises a listing of assets.

22. The system of claim 21 wherein the data record refers to such information capable of being associated with an asset.

23. The system of claim 21 wherein the mergeable data records refer to data records pertaining to same asset.

24. The system of claim 21 wherein the bibliographic set of data records refers to a creation date, auction date, auction house name, location, lot number, name of creator and provenance.

25. The system of claim 21 wherein the price data record refers to an auction price of the asset.

26. The system of claim 21 wherein the mergeable data records are pre-processed prior to comparison.

27. The system of claim 21 wherein the data records pertaining to the asset is updated based on information from a data source with higher ranking.

28. The system of claim 21 wherein the processor is further operable to generate a time series data of all the auctions corresponding to the asset.

29. A method for managing information, the method comprising:
retrieving one or more data sets pertaining to an asset from a plurality of data sources;
identifying one or more mergeable data records from the one or more data sets wherein identifying the mergeable data records comprises:
comparing a bibliographic set of data records;
comparing a price data record; and
comparing images from each of the one or more data sets;
combining the mergeable data records into a config file pertaining to the asset; and
updating a database arrangement with the config file wherein the database arrangement comprises a listing of assets.

30. The method of claim 29 wherein the data record refers to such information capable of being associated with an asset.

31. The method of claim 29 wherein the mergeable data records refer to data records pertaining to same asset.

32. The method of claim 29 wherein the bibliographic set of data records refers to a creation date, auction date, auction house name, location, lot number, name of creator and provenance.

33. The method of claim 29 wherein the price data record refers to an auction price of the asset.

34. The method of claim 29 wherein the mergeable data records are pre-processed prior to comparison.

35. The method of claim 29 wherein the data records pertaining to the asset is updated based on information from a data source with higher ranking.

36. The method of claim 29 wherein the processor is further operable to generate a time series data of all the auctions corresponding to the asset.
